(19) United States
(12) Patent Application Publication
(10) Pub. No.: US 2007/0195210 A1
(43) Pub. Date: Aug. 23, 2007

(54) Portable high definition audio visual projection system

(76) Inventor: Robert W. Rudzki, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/357,585

(22) Filed: Feb. 17, 2006

(51) Int. Cl. H04N 5/64

(52) U.S. Cl. 348/838; 348/836

(57) ABSTRACT

A portable high-definition television and theater entertainment and audio visual system that includes a movable pod formed with at least one side wall cooperating with a generally horizontal top to define an interior component volume and with spaced apart alignment passageways therein, and at least one recessible door. A removable component cage is received in the interior component volume and is formed with alignment guides coacting with the alignment passageways. The cage carries at least one audio visual component such as a media source and a projector. The system further incorporates one or more reversible panels configured with a projection screen side and an opposite second side adapted with decorative features that conceal the projection screen side when the panel is reversed. In combination, the various embodiments of the invention establish a convergence of high-definition television with digital art.

### BACKGROUND OF THE INVENTION

1. Field of the Invention

The invention is related to high-definition television, multimedia, and home theater entertainment and audio visual projection systems, and in one aspect exemplifies the convergence of these technologies with high definition, digitally reproduced imagery and art work.

2. Description of Related Art

Since the advent of the television, audio visual business users and entertainment system enthusiasts have continuously sought to improve the state of the art of home and business audio visual projection, and large screen display systems. Early televisions have evolved from self-contained black and white cathode ray tube (CRT) display sets, to color projection CRT systems employing projection lenses adapted to project large screen images. As improvements progressed, rear and forward projection systems gave way to small and large liquid crystal displays, light emitting diode (LED), and gas plasma displays, the larger of which are commonly referred to by those skilled in the art as glass panel or flat panel displays.

These systems have found a variety of applications that include business, home theater, and other entertainment uses that range from everyday television and multimedia viewing, to interactive gaming, and digital camera card photo projection, and slide shows. The preferred sizes and shapes of such devices are as varied as the myriad applications. For example, television programming viewing devices range from rectangular displays having diagonal, corner-to-corner dimensions spanning as little as two inches in hand held units, to as much as seventy-five inches, and more for large format displays.

Home theater, multimedia entertainment, business presentation, and interactive gaming applications have created markets for even larger displays ranging from one hundred inches to three hundred inches and larger. Some forward projection applications are limited in projected image size only by the power and resolution technology available to the projection equipment manufacturer and the cost tolerance of the user.

The size and complexity of the available equipment has led to improvements in the source media, and the present-day enthusiasts are focused ever-increasingly on what is often referred to by those skilled in the art as digital, high-definition television, or “HDTV” source signals and media. Older generation source television signals and media that are compatible for use with the vast majority of television and media projection devices typically offer a resolution that produces five hundred twenty five scan lines, which are displayed and refreshed repeatedly to form the displayed image.

With large format displays such scan lines may be perceived by the viewer and the resolution appears poor and unfocused as a result. Some improved television and media projection devices of larger size are equipped with line doubling technology that inserts an extra line between each line of the source media signal, which is averaged from the two surrounding lines, to produce one thousand fifty scan lines. In most implementations, the apparent result is a slight increase in the perceived resolution and focus of the displayed image.

With the continuing advances of computer display technologies and digital source media and signals, much greater resolutions were possible using various interlaced and flicker-reducing progressive signal processing technologies. In an effort to achieve higher resolutions and to improve the state of the art of television broadcast source media and signals, HDTV resolutions were introduced that increase the television signal and media source resolutions, which now approach that which are available with computer compatible digital display devices. However, the increases in HDTV resolution have not come without corresponding increases in cost. In contrast, the corresponding resolutions of digital, computer display technologies have continued to decline despite continuously increasing resolutions.

The corresponding technological evolution of television broadcast source signals and media towards digital technologies like HDTV has continued to converge with the continually evolving digital computer display technologies. However, the corresponding HDTV costs have continued to diverge. The HDTV glass panel, micro display, plasma, LED, and LCD technologies for large screen formats over forty inches may range between $5,000 and $10,000, and higher. In contrast, corresponding costs of large format digital computer display technologies, including high-resolution or high-definition projection display technologies have continued to decline. For example, highly flexible and multifunctional digital computer projectors may project images from thirty inches to more than three hundred inches, and may cost as little as $2,000, or less.

As a result, audio video enthusiasts, multimedia entertainment professionals, and business presentation users alike have sought to find improved ways to avail themselves of the more diverse programming benefits of HDTV source media and signals, without loss of the wide-ranging functionality and lower costs of digital computer source media and projection technologies. What continues to be needed and yet unavailable, is a cost-constrained audio visual display package and system that captures the benefits of HDTV within the investment paradigm of digital computer display technology.

Although many types of stationary, large screen LCD, rear projection, plasma, and glass panel HDTV televisions have been hailed by manufacturers as the next wave of television technology, the various flat panel or flat screen technologies remain inflexible and too expensive for a majority of consumers. Additional detriments of such devices continue to plague even the more affluent consumers, who although not constrained by investment costs, remain concerned over the fragility of such devices, the greater weight and dedicated wiring that prevents mobility, the large size of the stationary units and fixed screen dimensions thereof, and the overly reflective surfaces of the glass and similarly designed screens, which reflect ambient room lighting in ways that detract from enjoyment of such prior art televisions.

The present invention captures the cost, flexibility, reconfigurability, and functionality benefits of the digital computer technology, while also capturing the benefits perceived with HDTV technologies, but without the need to expend the extraordinary investment typically associated with gas plasma, micro display, glass panel, and high-resolution LED and LCD flat panel display technologies. In the context of the many innovative aspects of the invention, a new and heretofore unavailable range of capabilities is embodied in the portable, high-definition electric theater pods and panel configurations described herein. These capabilities are accomplished in new and novel ways and in a form factor that is compatible for use with an unlimited range of possibly desirable packaging arrangements, which include, for purposes of example, what those skilled in the furniture arts often refer to as movable and stationary end tables, coffee tables, credenzas, frames for art work, and the like.

### SUMMARY OF THE INVENTION

The present invention is directed to a portable high-definition television and theater entertainment and audio visual system. The system incorporates a movable pod that is formed with at least one side wall in ovoid shapes and in cuboid configurations having four side walls, and a bottom. Further included is a generally horizontal panel or top that cooperates with the at least one side wall to enclose and define a body having an interior component volume. Also included therein are spaced apart alignment passageways that are preferably formed in and about a floor panel or as floor rails spanning an inferior portion of the body and interior component volume.

A removable component cage is also included and is received within the interior component volume, and formed with lower or inferior alignment guides, rollers, rails, slides, and or alignment feet that are arranged for receipt about the alignment passageways. The component cage is configured with one or more shelves, or other similarly configured structures, that are adapted to carry at least one audio visual component such as a media source device and at least one audio visual projector or a combination thereof, which may be preferably positioned in a stacked arrangement on a shelf in the cage.

Next, the present invention is preferably adapted with a table-type top that may be configured as a deployable and stowable panel having a projection screen side and an opposite second side that may be adorned with decorative elements. The projection screen side is deployable to a generally upright projecting or substantially vertical or vertically angled position to receive a projected visual image from the at least one audio visual projector.

Preferably, the portable audio visual system may also be adapted with the deployable and stowable panel to be, or to cooperate with, the generally horizontal top or to cooperate with a fixed position horizontal top. Whether adapted as the deployable table-type top or to cooperate with the generally horizontal top seat, the panel is movable to a deployed position in the approximately vertical position for use as the projector screen. The panel is also movable to a stowed and substantially horizontal position to thereby expose the opposite second side or table-type top surface. In the opposite second side variation that may be furnished with decorative elements, art work and or any other desired indicia, pattern, or surface finish may be incorporated for continuous display during non-use of the screen when the projector equipment is powered off.

Preferably, multiple additional deployable and stowable panels of various sizes may be provided that are interchangeable with the generally horizontal panel or top, and the deployable and stowable panel and or separate components. In the separate component panel applications, the multiple additional panels may be sized and shaped as large rectangular or differently geometrically shaped panels that may have any diagonal dimensions ranging from several inches to hundreds of inches, and more preferably from thirty inches to three hundred inches, or more, or less.

These proposed multiple additional panels may be configured similarly to the previously described panels and may on one side be adapted as projector screens, with the opposite second side being decoratively configured with patterns, indicia, mirrors, art work, matted or framed art, and the like. In this way, all of the multiple additional panels may be stowed when not in use by reversibly mounting them to a wall to have the projection screen side facing against the wall, or by being positioned to have the opposite second side exposed with its optionally preferable decorative features.

When needed for display of a projected image, the multiple additional panels are reversed, or flipped over to expose the projection screen side for use, and repositioned on the wall or in a stand or on an easel, with the opposite second side or decoratively adorned side facing away from the projector. In further variations, the possibly preferred multiple additional panels may be of any desired size, including the popular so-called 16:9 (width by height) proportioned wide or large screen format, and an unlimited range of smaller and larger formats. Thus, it should be apparent that multiple such screen configurations may be used with different sizes and varying decorative features such that different rooms may be adapted with the most preferred variations and configurations of the contemplated additional panels. In these arrangements, the removable component cage may be repositioned about a room, or from room-to-room to project an image on any of such screens.

All of the preferred embodiments of the invention may also be adapted to include at least one movable structure such as a door that is positioned and adapted to cooperate with the at least one side wall to close and thereby further define the body with the interior component volume. The contemplated door or doors may be configured for movement between an open position exposing the interior component volume, and a closed position concealing the interior component volume. The door(s) may also be reversible, removable, and or movable about any desired axis. In other variations, the door(s) may be arranged to swing open from top to bottom, bottom to top, left to right, and or right to left, and any combinations thereof. The doors may be unitary and also may be configured with inserts and or inlaid decorative panels, which inserts and or panels in turn may be removable, reversible, mirrored, glass, metallic, varied with different finishes, different woods, or other materials.

When opened, such a door or doors may also be adapted as pocket doors to be recessed entirely and or partially, when opened, within the body and the interior component volume. The recess capability may be accomplished with use of slide rails mounted about the body, and or passageways arranged to accommodate, the preferred recess movement direction of the doors. The proposed optional or preferred passageways or slide rails may be formed in and or attached to a top, side, or bottom surface of the at least one side wall, a bottom panel, and or anywhere about the body that may be more preferred. Further, such doors may be incorporated about a single side, a front and or a back side, and about all or some of the sides of the interior component volume of the invention.

The component cage of the invention also contemplates other variations that may include passive vent apertures, active air moving devices such as fans, and releasable cable apertures, conduits, and passageways adapted to recess, conceal, stow, and guide electrical connector cables. Such features may preferably recess or conceal such cables to avoid untidy appearances that are often apparent with the interconnection back planes of many electronic devices such as audio visual sources and projector devices. Further, positioning elements or retainers may be incorporated to secure the audio visual components about the shelves of the cage. Similarly, security locking features may be incorporated about the component cage or other elements of the invention to enable attachment of cable, chain, and other types of anti-theft devices such as tethers for purposes of securing the cage to the pod, a credenza, a conference room table, and the like.

Further variations of the proposed movable pod may incorporate a bottom floor mounted series of alignment slots or passageways or rails. Such alignment features are contemplated for use with modified versions of the proposed removable component cage. The modified component cage may preferably be further formed with a plurality of shelves joined with laterally spaced apart rods and superiorly projecting handles and a plurality of inferiorly projecting alignment guide posts, rollers, and or feet arranged to releasably engage the alignment passageways. Together, the guides and passageways cooperate to minimize contact damage as the cage is removed from and replaced in the pod. Further, these alignment features enable precisely aligned prepositioning of the cage and its visual components relative to a screen.

Other aspects of the invention are embodied in the variations of the reversible and single sided display screens and panels, or panels that are also described herein. Many combinations and modifications of each of the proposed embodiments and variations thereof will become apparent to those skilled in the art with reference now to the various drawings and illustrations of the invention in connection with the detailed descriptions of the embodiments of the invention.

### BRIEF DESCRIPTION OF THE DRAWINGS

FIG. 1 is an elevated perspective view of a portable high-definition television and theater entertainment and audio visual projection pod system according to the principles of the present invention;

FIG. 2 is perspective view of the system of FIG. 1 with front doors partially opened and partially illustrating various components carried inside;

FIG. 3 is a perspective view of the system of FIGS. 1 and 2 with the front doors completely opened and partially recessed, and with the top panel in a vertical position, and depicting the component cage received with components;

FIG. 4 is a perspective view of the system of FIGS. 1-3 with the component cage removed for illustration purposes;

FIG. 5 is an exploded assembly view of the system of FIGS. 1-3 showing a configuration of the assembly arranged to receive the component cage;

FIG. 6 is a detail perspective view of the component cage;

FIG. 7 is an exploded view of FIG. 6;

FIG. 8 is a perspective view of the inventive projection pod system with various structure removed for purposes of illustration;

FIG. 9 is a perspective view of the projection pod system in operation;

FIG. 10 is a detail cut away view taken about detail view line 10 of FIG. 9, with certain structure removed for clarity and to show a portion of the edge frame of the reversible deployable and stowable panels of the invention;

FIG. 11 is another detail cut away view of the edge frame of FIG. 9 with certain structure removed for purposes of further illustration;

FIG. 12 is a section view taken about section line 12-12 of FIG. 9;

FIG. 13 is a perspective view of the portable high-definition television and theater entertainment and audio visual projection pod system in operation, and displaying an image on the vertical top panel deployed on the movable or stationary pod, and also depicting alternative deployable and stowable panel configurations, including a floor standing variation thereof;

FIG. 14 is a cross-section view taken about section line 14-14 of FIG. 13, with various structure removed for illustration purposes;

FIG. 15 is a partial detail view of a portion of the structure of FIG. 14 and depicting a variation of certain elements;

FIG. 16 is a section view taken about section line 16-16 of FIG. 13, with various elements removed for clarity;

FIG. 17 is an enlarged view of an element of the floor standing panel variation of FIG. 13;

FIG. 18 is a perspective view of the projection pod system projecting an image on a deployed and wall mounted projection screen panel, and also illustrating an easel supported variation of the deployable and stowable projection screen panel;

FIG. 19 is a perspective view of the projection pod system of FIG. 18 rearranged to project an image on yet another larger size variant of the inventive projection panel; and

FIG. 20 is a perspective view of the projection pod system having the component cage removed and relocated to project an image on the larger projection panel of FIG. 19.

### DESCRIPTION OF THE PREFERRED EMBODIMENTS

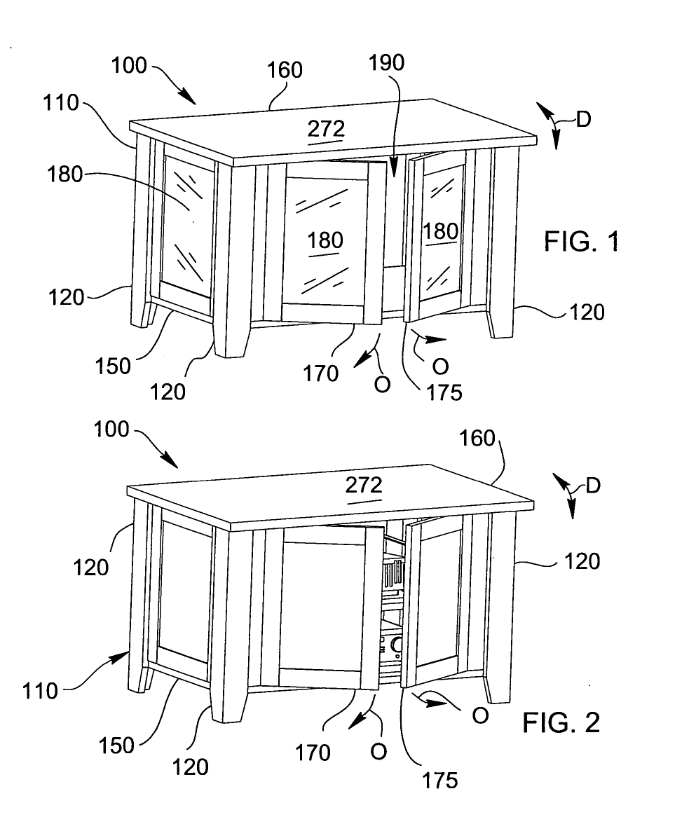

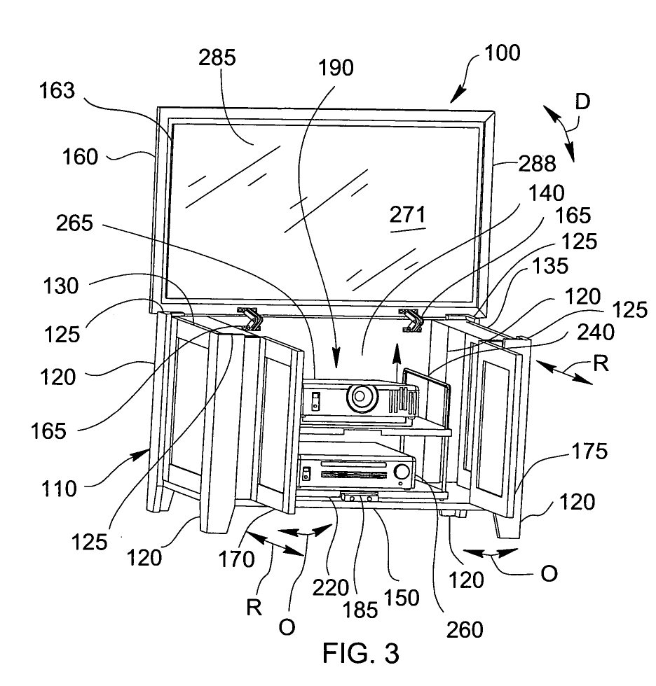

With continued reference to the preceding discussion and referring now also to the various figures and specifically to FIGS. 1-5, a fixed, stationary, and or portable high-definition television and theater entertainment and audio visual projection system 100 is disclosed. The system 100 incorporates a movable pod 110 that may take many possibly preferred shapes and forms. In one preferable embodiment, the movable pod 110 variation is formed as a furniture article that may have a generally cuboid shape with four legs 120, having upwardly projecting or upstanding top edges 125 (FIGS. 3-5), opposite side walls 130, 135 (FIG. 3), and an optional back panel 140, which may be replaced with one or more back or rear doors. Also included is an optional bottom or floor panel 150, a generally horizontal top or top seat panel 155 with a central access and vent aperture, a generally removable or movable panel 160, and at least one front movable structure, such as front doors 170, 175 and rear doors 170′, 175′.

Any of such panels and doors may be replaced with removable, reversible panels and or doors as may be preferred for a certain application of the invention. For capturing and releasably retaining the doors and or panels in closed positions, one or more catches or latches 185 may be incorporated. In variations, the catches or latches 185 may be spring-biased, magnetically capable, push-to-lock, push-to-open-type devices. Although shown in the various illustrations as generally positioned about lower panel 150, such devices may be incorporated anywhere about the body of the movable pod 110 and the components thereof. The latches and catches 185 may also be used in connection with the front and rear doors. Further, even though shown in use to secure the doors 170, 175 in a closed position, the catches and latches 185 may be further adapted to secure such doors 170, 175 in an open position, which is of particular utility for door configurations wherein the doors alternatively rotate outwardly and up to the open, recessed, and or retracted position.

The four legs 120 may be optional or may be integrally formed as part of any of the other components such as side walls 130, 135, back panel 140, bottom or floor panel 150, or they may be independent structures such as those shown. Additionally, the upwardly projecting or upstanding top edges 125 preferably project above the top surface of top seat panel 155 to establish an alignment capability to capture and align the movable panel 160 when in its stowed position.

Although not shown in the figures, those with experience in the furniture arts may comprehend that the top edges 125 of legs 120 may be replaced with similar features that may be in the form of rails or beads projecting up from the top seat panel 155 in a configuration similar to that shown in the figures. In this alternative adaptation, the movable panel 160 may be similarly aligned and captured on top of the pod system 100 and movable pod 110. The side panels 130, 135 and back panel 140 may be homogenous and uniform planar structures, which may be reversible and or removable, and which also may preferably be formed as framed and paneled structures having apertures, vents, glass panel inserts 180 (FIG. 1) or other decorative panels or inserts or finishes.

Any or all of the doors 170, 175 as well as any or all of the walls or panels 130, 135, 140, or others, may be further optionally adapted to incorporate such apertures, vents, decorative panels, inserts, inlays, or finishes. These may be in a variety of forms, which may also include, for purposes of example and without limitation, a generally centered inlay panel identical to, similar to, or different from the inserts labeled with reference numeral 180. Such inlay panels may be finished wood, mirrored surfaces, glass, stone, or may have a simulated finish or decorative feature or ornamentation. The inlay panels may also be adapted to display art work or photos, and may be adapted to be reversible so that the appearance of the pod 100 may be varied from time to time.

The movable panel or top 160 and or the optional panel seat 150 typically adjoin and cooperate with the at least one side wall 130, 135, and or the back panel 140 to define the body and to enclose and define the interior component volume 190. Further, the movable panel 160 may incorporate one or more alignment features adapted to cooperate with the leg alignment projections or top edges 125 for alignment of the panel 160 when stowed. More preferably, the movable panel 160 may incorporate one or more grooves or a continuous groove 163 that may function as a keyway or slot sized to align with and receive the top edges 125, or other similar alignment features.

To enable movement, recessibility, reversibility, and or removability of the doors 170, 175, the pod 110 may be adapted to incorporate one or more slide rails 195. The slide rails 195 may be mounted as desired in the body of pod 110, and can in some variations be mounted proximate to the side walls 130, 135.

Within the body and or proximate to a lower or inferior portion of the interior component volume 190 are optionally included spaced apart alignment passageways or slots 200. The proposed passageways, keyways or slots 200 may also be formed as alignment rails, guides, telescoping rails, or keyways 200 that are preferably formed in and or mounted about the optional bottom or floor panel 150 or as floor rails 200 spanning the inferior portion of the interior component volume 190.

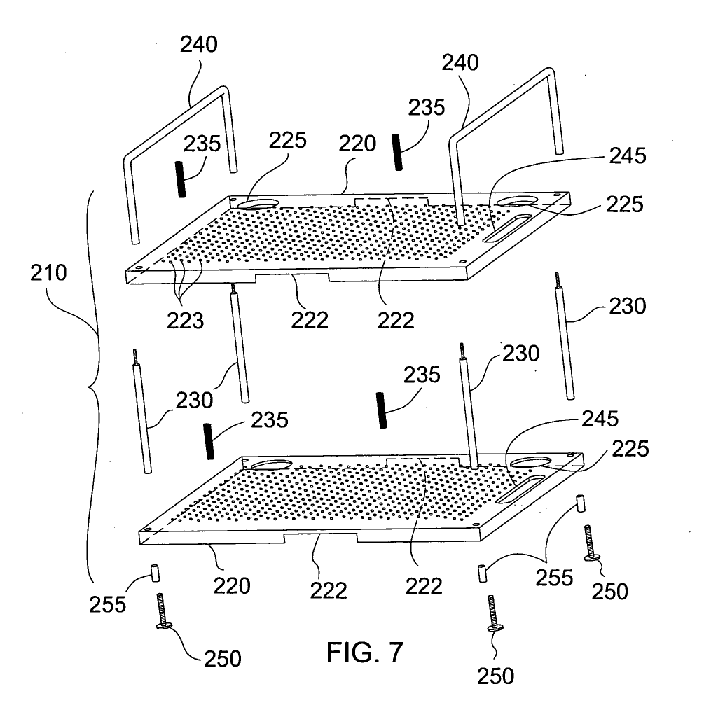

The invention is further directed to many optional and preferred versions of a component cage 210 integrally formed within and or sized for removable receipt within the body and the interior component volume 190. The component cage 210 may be formed as a wire cage, from sheet metal, and or as a multi-shelf box, and as shown to have a combination of shelves 220 joined by risers or rods 230. The rods 230 may extend upward to form or join to optional handles 240, and downward to form or join with lower or inferior alignment guides, rollers, slide bars, slide pads, and or alignment feet 250, which can be spaced from shelves 220 with spacers 255 (FIG. 7). The component cage 210 may be adjusted, removed from, and replaced into the movable pod 110 in a number of ways that include through the openings between the front and rear doors 170, 170′, 175, 175′, and through the aperture formed in the top seat panel 155. Additionally, the optional handles 240 may be further adapted to hang the component cage 210 from ceiling fixtures or hangers (not shown) for applications where it is preferred to elevate the component cage 210 for use in conference rooms, auditoriums, and or other home theater applications.

Although not shown in the figures, the contemplated alignment features 200, 250 may also be adapted to create a click or other type of audible or tactile feedback to occur when the cage 210 is replaced in its proper position in the interior component volume 190. This preferred alternative may further enhance the operation and utility of the removal capability of the cage 210. The shelves 220, and more preferably the lower shelf 220 may also incorporate a notch or cutout 222 if needed to enable a clearance about the door latches and catches 185, which may be mounted to the lower bottom panel 150 for securing the doors 170, 175 in the closed position.

The optional or preferable alignment guides or feet 250 are arranged and sized for receipt along and or within the spaced apart alignment rails or passageways 200. In other variations, the alignment guides or feet 250 may also be adapted to have a configuration similar to the form of the handles 240. However, in this alternative modification, the alignment guides or feet 250 would be adapted as inverted rails projecting downward beneath the bottom shelf 220. In this arrangement, they would replace the feet 250 and coact with or be receivable along and or within the alignment slots, rails, or passageways 200.

The guide features embodied in the cooperative rails or slides 200 and the guides, rails, or feet 250 establish the capability for pre-alignment and for movement and adjustability of the component cage 210 while received in the stationary or movable pod 110. During operation of the projection pod system 100 with the component cage 210 still received in the body and interior component volume 190 of the pod 110, the projected image may be more precisely positioned and aligned as a result of the adjustability.

Such guide features 200 and 250 are also useful to enable positive, tactile position feedback when removing and replacing the component cage 210 from and in the interior component volume 190 of the pod system 100. As a practical matter, the alignment or guide features 200, 250 also minimize abrasion damage that is possible from contact between the component cage 210 and the interior surfaces of the doors 130, 135, the optional bottom panel 150, the movable panel 160, and the pod system 100.

In further alternative variations, the guide features 200 and 250 are configured whereby the alignment passageways 200 and align feet 250 are cooperatively sized to prevent relative movement between the component cage 210 and the movable pod 110. In this way, the component cage 210 will remain aligned for projection without the need for adjustments prior to use of the projection system 100. This alignment capability is also useful when the component cage 210 has been removed for remote use and is then reinserted into the movable pod 110. In such optional fixed position modifications, the passageways 200 may be adapted as separate counterbores instead of slots or rails and positioned about bottom panel 150 to receive the cooperatively sized alignment guide feet 250.

The proposed shelves 220 may alternately be arranged without the riser rods 230 but joined instead with shelf side walls (not shown) joining the shelves in place of the riser rods 230. The contemplated shelf side wall embodiment may also have integrally formed apertures to be used as handles 245 (FIG. 7). In any of the proposed arrangements, the cage 210 is configured with the one or more shelves 220 or other similarly configured structures adapted to establish cavities defined above and between the shelves 220 and sized to receive and carry components. Such components may include, for purposes of unlimited example, at least one audio visual source device such as a digital video disk player or video cassette player-recorder 260, and or a standard or digital cable television receiver box 262. Other possible components also preferably include at least one audio visual projector 265, and combinations of such devices, which are now available in many configurations. Such components may preferably be positioned in a stacked arrangement about the shelves 220 as contemplated by the various illustrations.

The generally horizontal panel or top may be formed as a table-type top and may also more preferably be adapted to replace top seat 155 and be thereby adapted as the deployable and stowable panel 160. Even more preferably, a border or an edge frame 270 surrounds the deployable and stowable panel 160, which is generally configured with a projection screen side 271 and an opposite second side 272.

With continued reference to the various drawings and now also to FIGS. 1-5, 13, and 18, those knowledgeable in the related arts ought to comprehend that the generally movable panel 160 is deployable in the direction of arrows “D” to a generally upright or substantially vertical or vertically angled position. In this deployed state, the projection screen side 271 may receive a projected visual image “P” from the at least one audio visual projector 265, which thereby describes one preferred or optional variation of the panel embodiments contemplated by the invention.

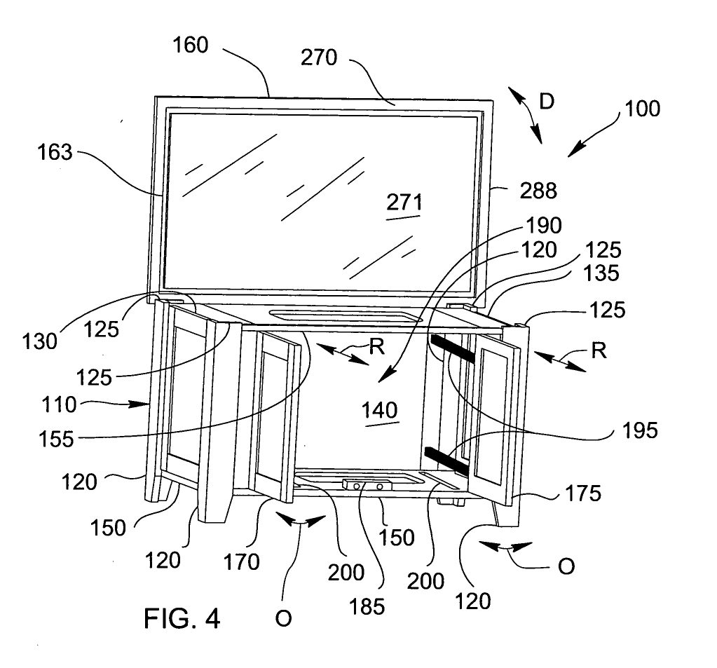

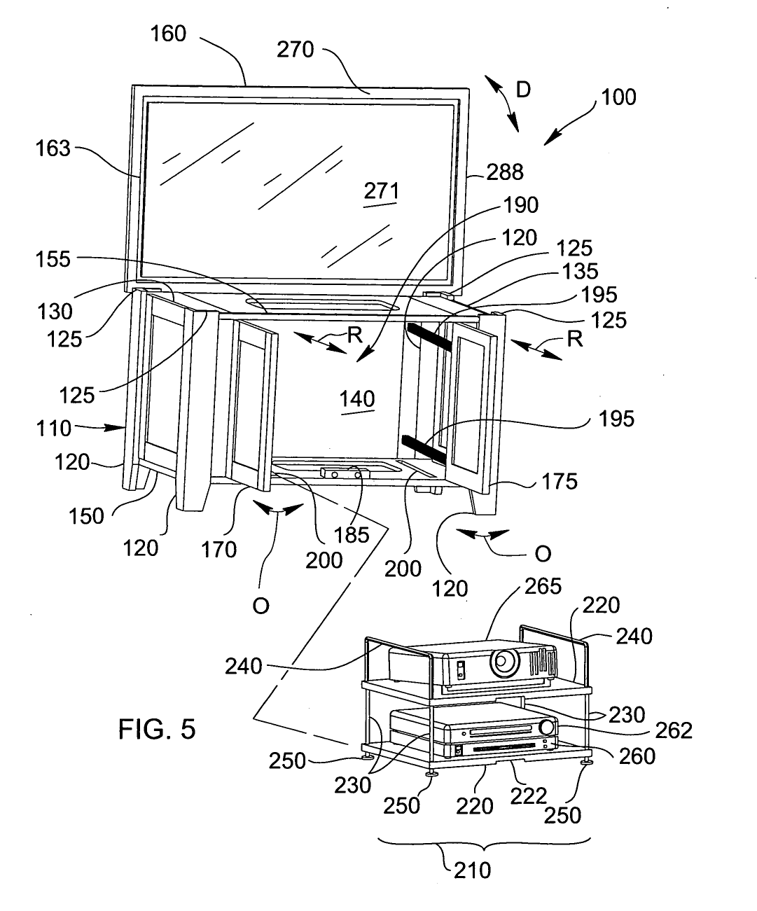

Although the figures illustrate generally rotational movement of the deployable and stowable panel 160 such as may be enabled by optional hinge elements 165 (FIG. 3), such hinge elements 165 may also be replaced with hook and or seating and frame capture elements (not shown, but within the skill of those knowledgeable in the furniture and related arts). In this further modification, the deployable and stowable panel 160 is lifted up and off the pod system 100 from its generally horizontal position, reoriented in the substantially vertical or vertically angled orientation, and reseated upon the modified seating elements (not shown) and in the position reflected by FIGS. 4 and 5. Many other configurations are also contemplated wherein the panel 160 is deployed into a wall mounted, easel mounted, or floor stand mounted configuration as described elsewhere herein.

Whether the movable panel 160 is fixed or deployable as contemplated in the various depictions, the deployable and stowable panel 160 in its hinged or seating element variations is also movable in the general direction of arrows “D” from the upright position to the stowed and substantially horizontal position described in FIGS. 1 and 2. In the stowed position, the generally horizontal panel 160 outwardly exposes the opposite second side 272, which may be configured as a table-type top surface. As stated elsewhere herein, the decorative opposite second side 272 variation may incorporate a plain or an ornately finished wood or simulated wood surface, as well as rough, etched, and or polished glass, stone, or other finished and unfinished surfaces, and or art work and other decorative features.

Optionally, the at least one movable structure such as doors 170, 175 are most preferably configured for movement in the general directions indicated by arrows “O”. When moved from the closed position contemplated in FIGS. 1 and 2, to the open position of the other figures, the interior of the body and the interior component volume 190 is exposed to enable access to the devices 260, 265 and for removal and replacement of the component cage 210. Such removable and replacement is also facilitated by removal of panel 160, as well as by adapting the size and shape of the central aperature in panel seat 155 to enable removal therethrough.

Even though shown in a configuration adapted for side directed, open-close movements, the contemplated door(s) 170, 170′, 175, 175′ are easily adapted for complete removability, reversibility, interchangeability, and for movement about any other desired and possible axis. The door(s) may also open from top to bottom, bottom to top, left to right, and or right to left, and all combinations thereof. Further, the movable structures may be slidable from side to side and may slide up and down and or may roll up in flexible door configurations, much like a roll-top-type desk closure.

Another more preferred variation of the contemplated door embodiments of the invention includes the doors 170, 170′, 175, 175′ to be configured for partial or complete receipt within the interior component volume 190. In this optional or preferred variation, the front doors 170, 175 or rear doors 170′, 175′ typically will be substantially movable in the direction indicated by arrows “R” and about upper and lower door pocket and or recess slide rails 195 (FIGS. 4, 5 and 8). The proposed door recess slide rails 195 may be selected to be in the form of what are often referred to as file cabinet drawer, telescoping-type slide rails, or may be integral passageways, slots, or keyways that may be formed in the opposite side walls 130, 135 or as separate components, or as a combination thereof, as is also contemplated by the invention.

Further variations of the door recess capability include doors that may open from bottom to top or that may roll up and be recessed beneath the top 155. The doors may also open and close about an axis positioned about a lower portion whereby the doors may then be recessed interiorly or exteriorly along the bottom panel 150. Another possible arrangement contemplates the doors opening generally as shown in the illustrations, but opening further to fold around and outside of, and to be positioned against (not shown) the exterior of side walls 130, 135.

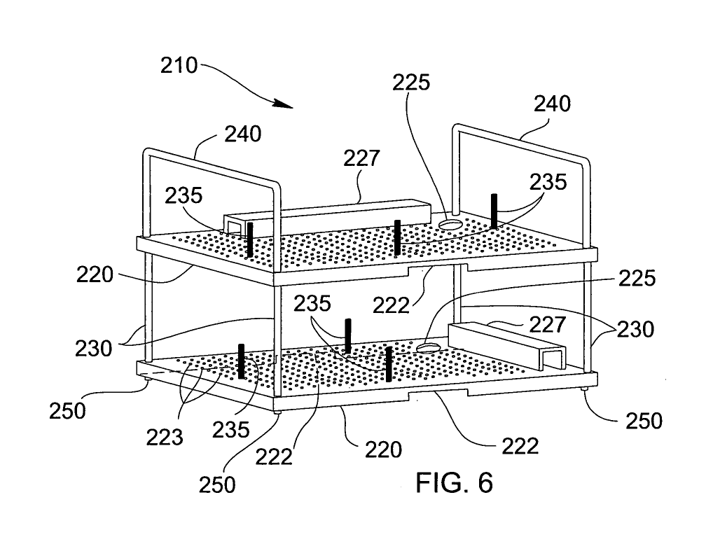

With continued reference to the many illustrations, and with reference specifically to FIGS. 6 and 7, it may be understood that the component cage 210 may incorporate further variations wherein the shelves 220 are modified to incorporate one or more additional features such as passive vent apertures 223. The vents 223 may be defined in the shelves 220. Further, although not shown in the figures, active air moving devices such as flat and quiet cooling fans, much like those used in computers and their power supplies, may be mounted about or upon the shelves 220, and about any other suitable location about or within the movable pod 110.

In addition, easy access or releasable connector cable retainers such as cable apertures 225 may be formed in and about the shelves 220 to enable concealed routing and stowing of electrical connector cables while maintaining an orderly and pleasing appearance of the component cage 210 and the pod system 100. Also contemplated are connector cable retainers in the form of conduits and passageways 227 (diagrammatically illustrated in FIG. 6), which may be mounted upon and or about the shelves 220. Such features may preferably recess such cables to avoid untidy appearances that are often apparent with the interconnection back planes of many electronic devices such as audio visual sources and projector devices. The variously configured shelves 220 may also be further modified with additional cable apertures 225, which may be included about all four corners of shelves 220, or in any other preferred arrangement to implement other optionally preferred cable routing and retaining capabilities. Further, the apertures 225 and any other such features of the shelves 220 and the component cage 210 may incorporate features such as polymeric or rubber gromments or other abrasion reducing or decorative features that may be preferred to improve aesthetics and or to reduce wear on such cables and connectors during routing, retaining, and other use.

Among many other possible modifications, the shelves 220 may also incorporate optional or preferred underside notches or cutouts 222 (FIGS. 6 and 7). These cutouts 222 are useful in embodiments of the portable pod 110 that are adapted with the magnetic, spring biased door catches 185. Alternative preferred modifications include shelves 220 without the notches 222, for use with low profile catches, or where the guide feet 250 are adjusted to create clearance between the shelves 220 and the catches 185.

The passive vent apertures 223 have sizes and positions adapted to additional purposes. In addition to lightening the weight of the shelves 220 when fabricated from stronger aluminum or steel materials, the apertures 223 are also adapted for use with component positioning posts or risers 235 (FIGS. 6 and 7). The positioning posts 235 may be fastened through the apertures with nuts and washers (not shown), and may be self-threading into the apertures 223, or positioned and held in place in a friction fit arrangement, among other possibilities. The positioning posts 235 are typically positioned about the sides of the components 260, 262, 265 to prevent shifting or displacement as the cage 210 is moved about.

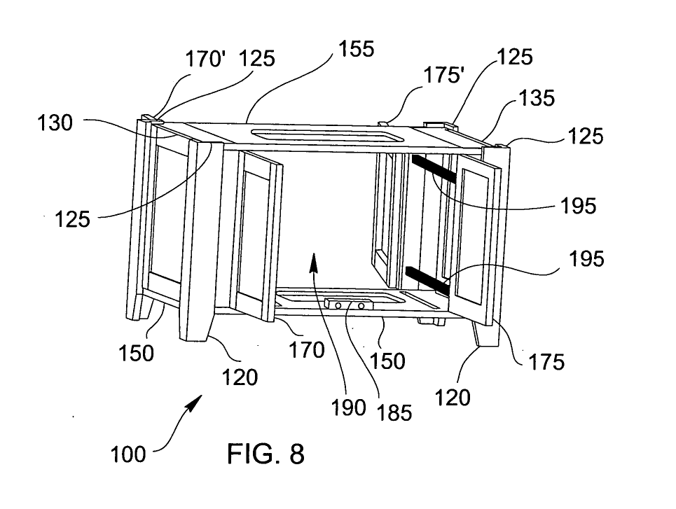

In FIG. 8, another possibly preferred modification is depicted, which is compatible for use with all of the embodiments of the invention. In this arrangement, the rear doors 170′, 175′ are incorporated to replace back wall 140. With many possible uses, this configuration of the doors 170′, 175′ enables ready access to the component cage 210 and the electronic or other components thereof. The additional access capability may be very useful for adding cable connections, such as those that may be needed to connect the projection pod system 100 to a computer or network, a gaming system, or for cable management and other component backplane maintenance activities.

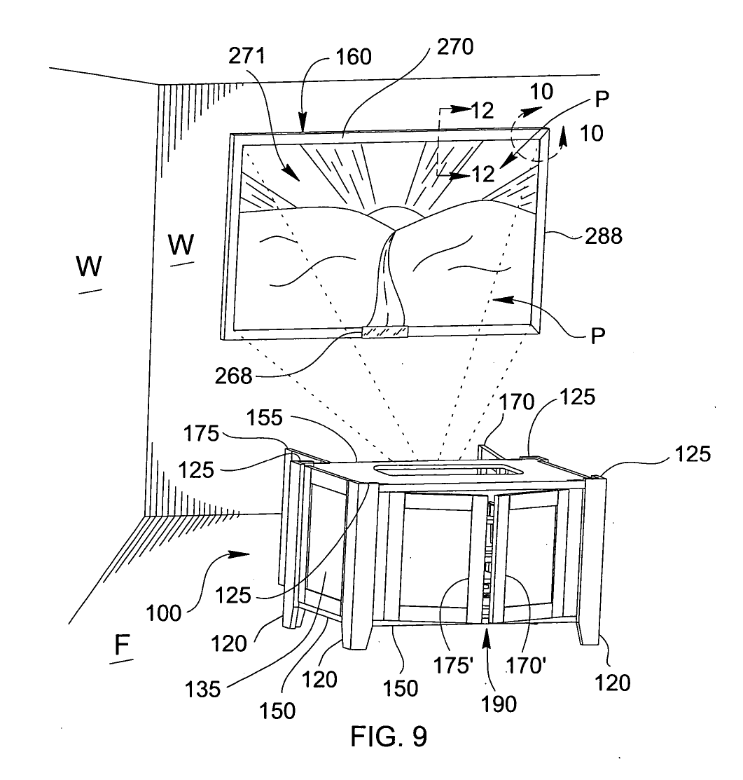

With reference now also to FIG. 9, the projection pod system 100 according to the principles of the invention is illustrated in an operational configuration. As depicted, the pod system 100 is positioned about a floor “F” and is projecting a video signal, image, or picture “P” onto to the projection screen side 271 of deployable and stowable panel 160 which is mounted about a wall “W” with wall mounts that are hidden behind the deployed wall mounted panel 160.

The wall mounted movable panel 160 also contemplates variations shown in FIG. 9 and elsewhere, wherein a reflector element 268 is mounted about any portion of edge frame 270. Preferably, the reflector element 268 is selected from any sheet material that is capable of reflecting the electromagnetic energy transmitted from remote control devices (not shown). In this way, users of the projection system 100 may operate the at least one audio visual device 260, 262, 265. Thus, users can control the devices 260, 262, 265 from any vantage point in a room so long as the remote control device may be generally aimed at the deployed panel 160 and the reflector element 268. In turn, the electromagnetic energy, which is usually in the infrared spectrum, will be reflected from the remote control device by the reflector element 268 toward the at least one audio visual device 265.

Although the reflector element 268 is depicted in FIG. 9 to be affixed to a generally lower portion of the edge frame 270, the contemplated reflector 268 of the projection system 100 may be mounted anywhere on the panel 160, the frame 270, the projection screen side 271, the opposite second side 272, or anywhere else in the room or on the wall “W” so as to reflect infrared energy from a remote control device. Although the reflector 268 is depicted to be a separate material affixed to edge frame 270, optionally preferred variations also include the use of coatings that may be applied to edge frame 270, or selection of a material from which to fabricate edge frame 270, which material can be polished in part to be reflective and to serve the same purpose and function of reflector element 268. Further optional modifications include selection of materials or coatings for a part of or the entire projection screen side 271 that are similarly reflective of infrared energy.

Here, the projection pod system 100 is shown with the table-top variant of panel 160 in its deployed position hanging on the wall with wall mount hangers or brackets that are hidden from view. Rear doors 170′, 175′ are shown partially opened to expose interior component volume 190, with the front doors 170, 175 shown fully opened, but not recessed, so that image “P” may be projected on the wall mounted panel 160.

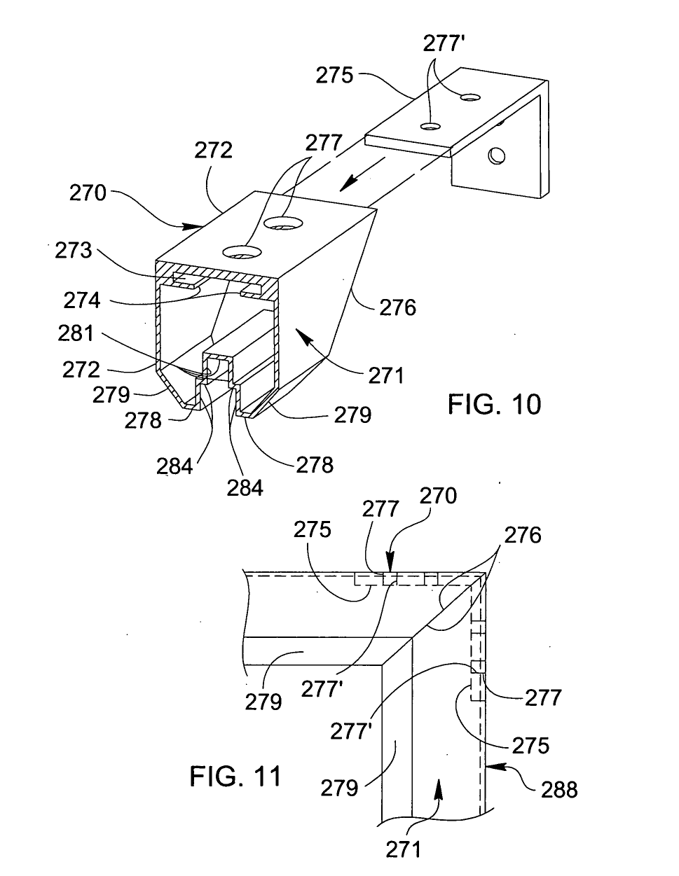

The additional, wall-mounted deployable and stowable panels incorporate a variation wherein the edge frame 270 is adapted with a releasable side and or edge rail, which is discussed in more detail below. With continued reference to the preceding figures, and now also especially to FIGS. 10, 11, and 12, new and novel aspects of the panels of the invention are disclosed. FIG. 10 depicts an enlarged detail view of a reoriented portion of the edge frame 270 with portions of certain structure removed for clarity.

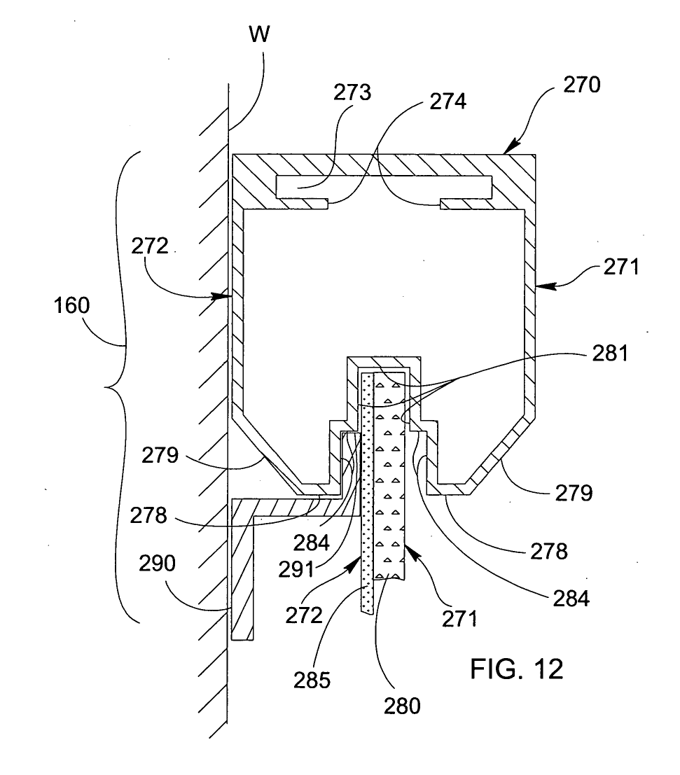

FIG. 11 presents another enlarged detail view of the edge frame 270, but rotated, and redrawn with certain other structure illustrated for additional discussion purposes. FIG. 12 is a cross-section view of a portion of the structure depicted in FIGS. 10 and 11. The frame edge 270 is described here to be generally symmetrical from front-to-rear, which enables the frame edge 270 to establish the panels 160 of the invention to be reversible and double-sided. Asymmetrical frame cross-sectional variations are also contemplated that can be understood by those skilled in the art even though they are not illustrated in detail here.

Those having skill in the art can comprehend that in one of the preferred embodiments of the invention, the deployable and stowable panel 160 may incorporate the edge frame 270 including the above-described projection screen side 271 and the opposite second side 272. The frame 270 also preferably incorporates a corner joint and or joint keyway 273 that is defined by support tabs 274.

The keyway 273 may have many possibly desirable configurations and is most preferably arranged to receive an angle joiner 275 (FIGS. 10 and 11), which joins adjacent miter joint edges 276 of the edge frame 270. Although shown here in generally ninety-degree, right angle configurations, the keyway 273, angle joiner 275, and the miter joint edge 276 may take many shapes, which may accommodate any shape, dimension, or arrangement of components. Once the angle joiner 275 is received in the keyway 273, quick-release or more permanent threaded fasteners are received into the fastener holes 277 of the frame edge 270 when registered with holes 277′ of the angle joiner 275, to securely join the edge frame sides or elements 270 together.

The edge frame 270 may be formed from a number of suitable materials and its selection will depend upon the particular environment (indoor or outdoor), size, shape, and other variations of the intended application. In one possibly preferred configuration, the frame 270 may be formed from steel, stainless steel, anodized steel, electroplated metal, anodized aluminum, and or a polymeric thermoplastic material. In another alternative arrangement, the frame 270 is formed from an extruded aluminum material such as a black powder coated aluminum 6063-T5 temper stock. The frame dimensions dictate the needed strength and durability of the material to be selected.

The frame 270 also incorporates an inner frame side 278, which may optionally include a frame edge bevel 279 for improved flexural strength and appearance characteristics. As assembled, the frame 270 preferably will receive a panel support core 280 that is selected from a dense cardboard, foam core board, plywood, laminate, or other suitable alternative or preferred material. The frame edge bevel 279 may also be coated, include a finish, and or be otherwise shaped, arranged, and or angled as depicted in the figures to reduce or eliminate a reflection of any portion of the projected picture that may be larger than the projection screen side 271 and which may overlap onto the frame edge 270 proximate to the frame edge bevel 279. This added feature produces an improved aesthetic appearance and can reduce distracting reflections of such an overlapping projected image that may bleed outside the perimeter of the projection screen side 271 of the panel 160.

Many additional types of such panel support cores 280 are also contemplated for use with the invention and may further include what is known to those knowledgeable in the related fields of technology as “gator” boards and Sintra® boards. Gator board is a generic name for materials that are typically fabricated from a rigid polystyrene foam core laminated between two face veneers of resin-impregnated wood fibers that are well-suited for purposes of the invention. The veneers may be obtained in a variety of colors and finishes. Such materials have been found to be of utility for purposes of the invention when selected to have matte veneer finishes, which are well-suited for use as the contemplated projection screens. Further, thicknesses in the range of about 0.125 inches to about 0.5 inches, and more preferably in the range of between approximately 0.1875 and 0.375 inches.

For applications of the invention requiring variously shaped panel support cores, Sintra® sheet material may be perferred for use. Sintra® is the brand name for a line of such sheet products available from a number of suppliers including Alcan Composites USA Inc.

Glasgow, Ky., U.S.A. Sintra® panels are supplied in rigid poly vinyl chloride (“PVC”) foam boards, which are a moderately expanded, closed-cell PVC sheet. This type of sheet material is available in thicknesses from about one millimeter to about nineteen millimeters, and more preferably between about three and six millimeters in thickness. Many colors and finishes are available. Also, this material resists moisture, many chemicals and may be processed like wood. Further, since it is a thermoplastic, it may be softened to impart lofted surfaces and shapes for added flexibility in preparing the panel support cores 280 of the invention.

The panel support core 280 is received in a panel support core seat 281 defined between the inner frame sides 278. For improved strength and for applications where it is not preferred to remove and replace the panel support core 280, one or all of the peripheral edges thereof may be adhesively or otherwise fastened into place in the panel support core channel or seat 281. As described in more detail below, the panel support core seat or channel 281 is sandwiched between mounting bracket seats or channels 284 (FIGS. 10, 12). Although a slight interface is reflected in the various drawings, the panel support core 280 may be seated in a friction fitted arrangement wherein there is not any gap within seat 281.

Although possibly not preferred in all applications, in some intended uses of the inventive movable panel 160, it is alternatively desirable to incorporate about the opposite second side 272, decorative artwork, simulated wood, artwork mattes, framed artwork, mirrors, and other patterns and indicia. These features on opposite second side 272 of the panel 160 may be displayed continuously when the pod 100 is turned off during non-use. Such artwork or other indicia may include the artwork “A” as shown in several of the drawings and illustrations.

More preferably, the decorative indicia “A” is formed as a surface and or layer 285 that is attached to the panel support core 280. Even more preferably, the contemplated layer 285 of the artwork and indicia may be imprinted, adhered, fastened, and or laminated directly onto the opposite second side 272 of the panel support core 280. In this preferred or optional configuration, the panel support core 280 on the projection screen side 271 operates as the projection screen, and on the opposite side to have integral surface or layer 285 to be the opposite second and decorative side 272, which essentially establishes a double-sided and or reversible embodiment of panel support core 280.

The projection screen side 271 of the frame 270 may be similarly adapted to incorporate a reflective projector screen sheet or panel layer (not shown) but it is more preferable that the projection screen side 271 is formed by the selected foam core panel 280, which from most suppliers will be supplied with the matte veneer surface. For applications where it is desirable or even preferred to have the capability to remove and replace the panel support core 280, a releasable edge rail 288 may also be incorporated. See, for example, FIGS. 2, 9, 11, and 19. The releasable rail 288 may be adapted to be a single side of the edge frame 270, and may include the fastening methods and components described elsewhere herein. Alternatively, the releasable rail 288 configuration may be adapted so that all sides of the edge frame are releasable.

In combination with the many variations of the contemplated frame 270, these enhanced capability alternatives of the panel support core 280 create an even more capable, double-sided, reversible panel that may be adapted in any of the contemplated panel configurations described elsewhere herein. In further view of the new edge frame 270 elements, and particularly in view of the panel seat 281 and panel support core 280, those skilled in the related arts can comprehend that the decorative side 272 may also be suitable for incorporating framed and matted artwork, as well as glass or acrylic protected and covered artwork and indicia.

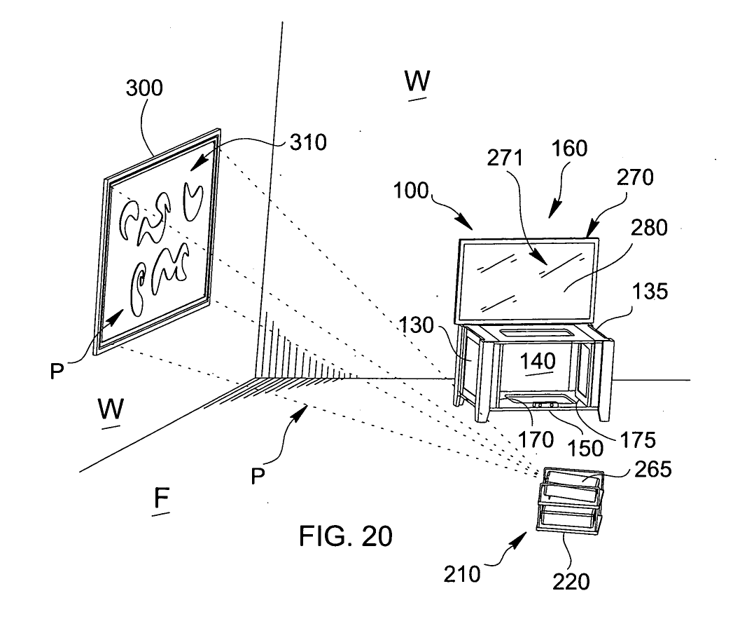

With continued reference to FIGS. 12 and 19, the edge frame 270 also cooperates with wall mount hangers or brackets 290 that may be flush mounted to a wall “W”, and which have a hook end 291 that is shaped and sized for receipt in the bracket seats 284. In this configuration, the brackets 290 are preferably hidden from view in use giving the deployable and stowable panels an aesthetically pleasing appearance.

Additionally, the wall mount hangers or brackets 290 more preferably incorporate a polymeric coating (not shown) about the hook end 291 that is in contact with the seats 284 of the edge frame 270. This avoids scratches and reduces abrasion wear on the edge frame 270 due to repetitive contact between the edge frame 270 and the brackets 290, as the panel is reversed.

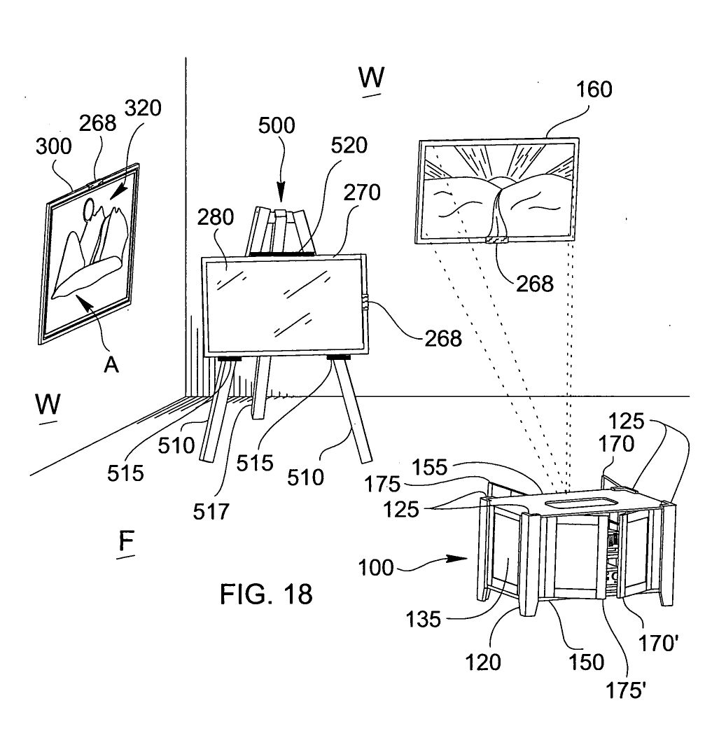

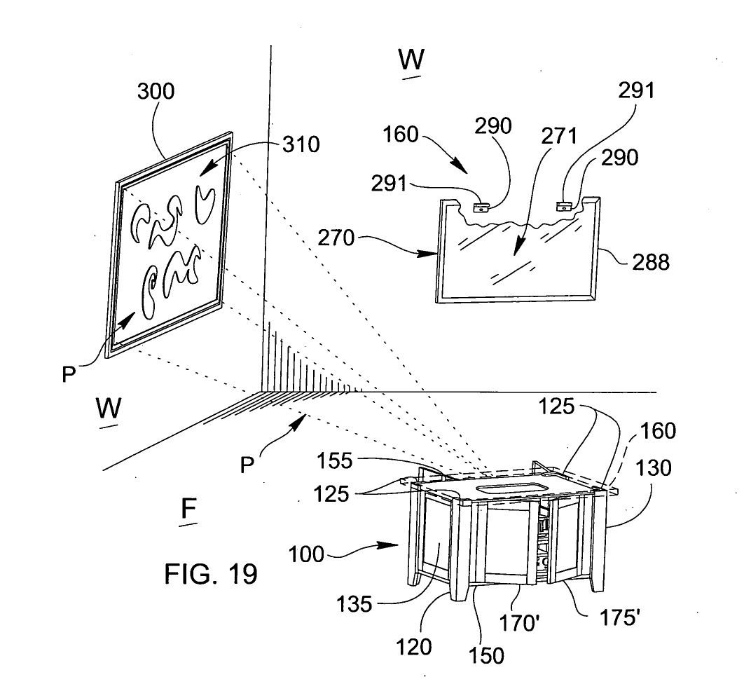

The invention is also directed to use of the variations of the pod system 100 and the component cage 210 for projecting images “P” upon multiple additional deployable and stowable panels such as those illustrated in FIGS. 18, 19, and 20. In FIG. 18, the component cage 210 is shown received in the stationary or movable pod 110 positioned on the floor “F” and aligned to project an image “P” on the deployable and stowable panel 160 as it is vertically deployed and or mounted on the wall “W”. An additional, larger sized deployable and storable panel 300 is also depicted here that is releasably or fixedly mounted on a wall “W” with mount hangers or brackets 290.

The proposed panels such as multiple additional deployable and stowable panels 300, may be stand alone panels and or may be adapted for interchangeability with the generally horizontal panel or top, and deployable and stowable panels 160. In the stand alone and separate component applications of the multiple additional deployable and stowable panels 300, the multiple additional panels 300 may have any preferred dimensions be preferably sized and shaped as large format rectangular or other geometrically shaped panels 300. Exemplary and preferred dimensions may range from 12 or so inches across a diagonal, to 300 inches, 400 inches, and larger.

These proposed multiple additional panels 300 are even more preferably similar to the previously described deployable and stowable panels 160, and may include the reversible and double sided frame edge 270 and may be assembled in identical and or similar ways. As seen in FIGS. 9, 13, and 18-20, on one side, the panels 300 incorporate a projector screen 310. The opposite side 320 is decoratively configured with patterns “A”, indicia, art work, and the like.

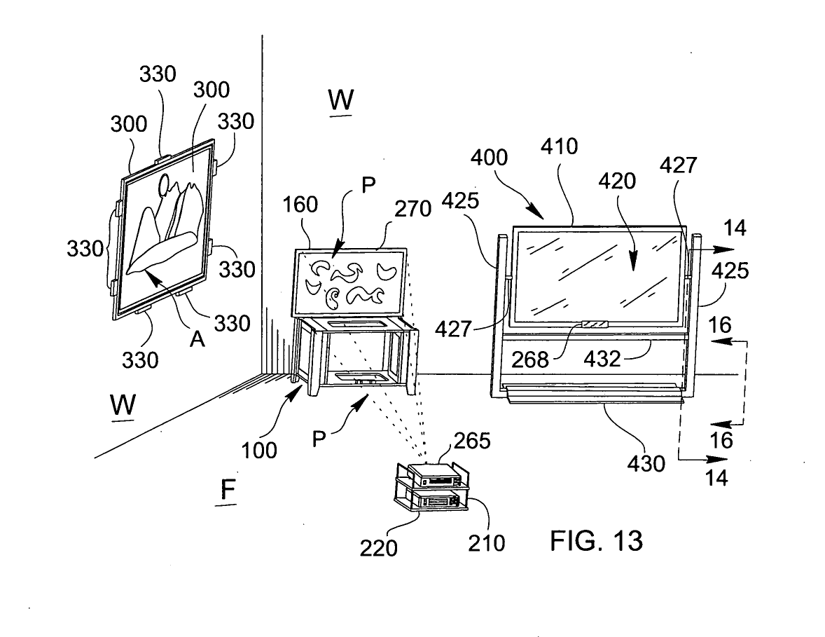

As specifically illustrated in FIGS. 13 and 18, the exemplary multiple additional panels 300 are stowable when not in use by reversible mounting to a wall with mounts 290 to have the projection screen side 310 facing against the wall, and with the opposite second side 320 exposed to the room, and showing the decorative art work or pattern “A”. Conversely, during use for display of a projected image “P”, the multiple additional panels 300 are removed from the wall, reversed to expose the projection screen side 310, and replaced on the wall to have the opposite second side 320 facing against the wall and concealing any decorations or art work.

FIG. 13 also depicts in a block representative form, additional wall hangers 330 that can be decorative hangers such as rings, decorative brackets, or other ornate or ornamented wall hanger elements that may be preferred by the user. Such additional wall hanging features 330 can be used alone or in combination with the brackets 290. When used in combination, the hangers 330 can be mounted directly to a surface of the edge frame 270 to hang the panel on the wall. Alternatively, such wall hangers 330 may carry or be connected to the brackets 290, or they may be modified to incorporate a feature identical or similar to the portion of the brackets 290 that captures the frame seats 284 of the edge frame 270.

In yet other possibly preferred configurations described in FIGS. 13-17, a floor stand support embodiment 400 is contemplated to include another reversible, multiple additional deployable and stowable pivotable panel 410. This variant includes a projector screen side of panel 420 that is pivotally carried from stand risers 425 by pivot bearings 427. The stand legs or risers 425 project up from a floor stand support plate 430 that rests on the floor. The risers 425 are received and fastened beneath the support plate 430 and may be fastened thereto. Further possibly preferred configurations of the floor stand 400 can include an anti-spread support cross bar 432 that may add further structural rigidity for certain applications. In other modifications wherein cross bar 432 is undesirable, the added structural rigidity capability can be implemented with pivot bearings 427 being further adapted to engage risers 425 to establish the anti-spreading, support capability otherwise available with optional cross bar 432.

Other optionally preferred variations of any of the embodiments of the invention further contemplate that the movable panel 160 and the multiple additional deployable and stowable panels 300, as well as the reversible pivoting panel 410 and the stand risers 425 being adapted with decorative finishes that can be selected to compliment, coordinate, and or match the finishes of the other components of the projection system 100. With these added aesthetic features, such components can match and complement the finishes of the movable pod 110 and other furniture that may be situated about the area.

Additionally, other variations of the multiple additional deployable and stowable panels 300 and the reversible pivoting panel 410 contemplate embodiments where both sides 310, 320, 420, are reversibly adapted with decorative features and or types of artwork. These configurations are well suited for art displays and the like wherein it is desirable to use the panels 300, 410 for purposes other than projection screen applications. With these variations, viewers may observe a series of such panels 300, 410, such as during an art show. After viewing, all such panels 300, 410 may be quickly reversed whereafter the viewers may observe an entirely different panorama of decorative and artwork displays.

Alternatively, it may be preferable for the stand risers 425 to be received in and fastened to brackets 435, which are attached beneath the plate 430 as shown, or above or about the plate 430 in other configurations that may be suitable for other applications. Here again, in the floor supported, free-standing configuration embodiments of the invention described previously, and in combination with the many other arrangements of panels 160, frames 270, and panel support cores 280, many possible double-sided and reversible deployable and storable pivotable panels 410 are contemplated. Further, the support plate 430 and the brackets 435 may also preferrably be adapted for width adjustability so as to accommodate different sized reversible pivoting panels 410. More specifically, the outer legs of risers 425 may be adjustably received in the brackets 435. In further alternatives, the brackets 435 may be adjustable about plate 430. In any of these variations, the width across the risers 425 may be thereby adjusted to accommodate differently sized reversibly pivoting panels 410.

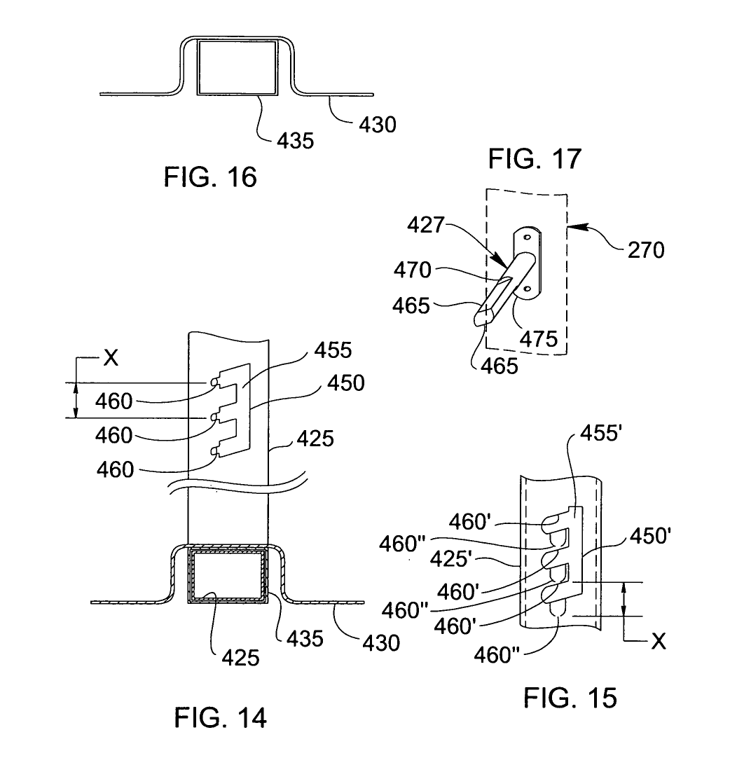

In FIG. 14, a cross section view is shown to illustrate a side view of a portion of the floor stand support plate 430, which is depicted for purposes of illustration, but not for purposes of limitation, to be a generally hat-shaped section. The floor stand support plate incorporates about an underside recess the bracket 435, which in turn is received with a horizontally projecting portion of the stand riser leg 425. Additionally, the upwardly projecting portion of the stand riser 425 is shown with an adjustable height pivot slot 450 that incorporates height adjusting keyway 455 and pivot lock slots 460. In FIG. 15, an alternative riser leg 425′ is shown to have an adjustable height pivot slot 450′ with a vertical height keyway 455′, which also includes modified pivot lock slots 460′. FIG. 16 shows the plate 430 with the bracket 435 mounted underneath, and without the leg 425 received therein.

The adjustable height pivot slots 450, 450′ cooperate with the pivot bearing 427, that are illustrated in more detail in FIG. 17 to have angled and opposingly parallel lock surfaces or key lock seats 465 formed on bearing post 470. The base 475 is mounted on an outer face of the edge frames 270 to project outwardly towards the risers 425, to cooperate with the adjustable height pivot slots 450, 450′. In operation, the angled lock surfaces or key lock seats 465 are seated in the pivot lock slots 460, 460′, which reversibly fixes the position of the pivotable panel 410. Alternative configurations contemplate mounting the pivot bearings 427 as risers 425 and forming the pivot slots 450, 450′ in the outside faces of edge frame 270.

When the double-sided and reversible deployable and storable pivotable panels 410 are to be reversed or flipped, the panel 410 is slightly lifted to unseat the key lock seats 465 into the adjusting keyways 455, 455′. The panel 410 is then rotated top over bottom. Thereafter, the panel 410 is slightly adjusted lower whereby the key lock seats 465 are reseated into a selected height position in one of pivot lock slots 460, 460′. In this way, the panel 410 may be reversed as needed to expose either side, and may be adjusted to a preferred height.

Those with knowledge in the relevant fields of endeavor should understand that even though the figures depict three such pivot lock slots 460, 460′, any possible number of such pivot lock slots 460, 460′ may be incorporated for infinitely variable height adjustments. In addition, although a slot, key seat, lock slot arrangement is shown, the height adjustability of the invention also contemplates a variety of other height adjustment and locking arrangements. For example and with continued reference especially to FIGS. 14 and 15, it can be understood that the spacing of the pivot lock slots 460, 460′ may be adjusted to have a distance of “X”. The distance “X” can be any desired distance and will depend upon the preferred arrangement and height adjustability of the reversible pivoting panel 410.

In many optionally preferred embodiments, the preferred distance “X” varies between about 3 inches and 36 inches, and more preferably between about 6 inches and 18 inches, and even more preferably is between approximately 9 inches. Further variations of any of the preceding embodiments are also depicted in FIG. 15 wherein pivot lock keyways or slots 460″ are included and have yet another orientation to cooperate with pivot lock seats 465 of the pivot bearing 427. In this alternative preferred variation, the lock seats can be adjusted to the preferred orientation of the modified slots 460″.

Even further variations of any of the embodiments of the invention are contemplated wherein the adjustable height pivot slots 450, 450′ are formed in a reinforcing plate (not shown, but similar to the configuration of FIG. 15) sized to be connected to the risers 425 or a portion of the panels 160, 300, 410. In this optionally preferred modification, the reinforcing plate may be made from a strong metal and be attached to the risers or a portion of the panels 160, 300, 410, which may be formed from a material having less strength than the contemplated metal plate.

Such preferred alternatives may also include expandable circumference fasteners, retainers, bolts, or posts that replace the posts 470 shown here, and which may be used in friction fitting configurations of the adjust height pivot slots 450, 450′ that eliminate the need for the pivot lock slots 460, 460′. Such expandable fasteners are well-known in the related fields of technology and can be acquired from many suppliers, including, for example and without limitation, the Avibank Manufacturing division of SPS Technologies, North Hollywood, Calif.

In these variations, such modified, expandable posts are moved into the desired position, and actuated to expand the circumference, which establishes a locking friction fit against the side edges of the adjustable height pivot slots 450, 450′. In any of the configurations that may be comprehended by the embodiments of the invention, the reversible, double-sided panels may be thereby further augmented with a flip and lock capability to further improve the convenience with which the panels may be flipped over and reversed.

In yet another variation to any of the preceding embodiments, the deployable and storable panel 160 is removed from the pod 110 and deployed on an easel floor stand 500, as shown in FIG. 18. Such an easel configuration 500 may incorporate adjustable easel legs 510, 517, bottom easel supports 515 to support a bottom edge of the panel 160, and an easel support 520 that is adjustable to retain the panel 160. In another variation, the support 520 is adjustable to configure the vertical orientation of the panel 160 relative to the projection pod system 100. This alternative configuration can establish a keystone effect minimizing capability and may even eliminate the keystone effect resulting from the relative height and angular displacement between the panel 160 and the projector device 265.

More preferably, a suitable easel is selected that incorporates an adjustable rear leg, which here may be illustrated as leg 517. Such adjustability characteristics will establish the capability to arrange the panel 160 to be in a generally vertical position as may be desired to minimize undesirable keystone effects. Many such easels are available from a wide variety of suppliers and include, for purposes of example without limitation, tilt and height adjustable easels sold as “RTA Studio” aluminum floor and table easels sold as model numbers 13167, 13168, 13172, 42167 available from many office and art products suppliers including Dick Blick Company of Galesburg, Ill., U.S.A.

Any or all of the many possible additional preferred and optional components, including the multiple additional panels 300 may be provided to users in the form of complete kits and as later acquired components and accessories. In this way, the pod system 100 may be used in one room for most purposes, but may also be used whereby the component cage 210 is removed from the interior component volume 190 and carried to another room or location where multiple additional panels 300 may be located.

Thus, the pod system 100 may remain in one location, while the devices 260, 265 may be positioned elsewhere. For example, in FIG. 19, the projection pod system 100 is shown projecting an image “P” onto the panel 300, and with another panel 160 depicted with phantom lines and in its stowed position about the movable pod 110. In FIG. 20, the component cage is depicted removed from the pod 110 and remotely repositioned to project the image “P” onto the panel 300. Additionally, as already described, the pod system 100 is compatible for use in connection with a number of other types of panels and screens including those available from Da-Lite® Screen Company, Warsaw, Ind., U.S.A., which produces a range of screens as large as 200 inches across. Many other suppliers are similarly capable and make screens even larger.

Although the present invention has been described in detail in connection with the discussed embodiments, various modifications may be made by one of ordinary skill in the art without departing from the spirit and scope of the present invention. Therefore, the scope of the present invention must be determined by the attached claims.

The invention claimed is:

1. A portable high-definition television and theater entertainment and audio visual system, comprising:
a pod formed with at least one side wall cooperating with a generally horizontal top seat to define a body having an interior component volume and with spaced apart alignment passageways defined about the body;
a removable component cage received within the body and formed with alignment guides arranged to engage the alignment passageways, and being further configured to carry at least one audio visual component; and
a movable panel received about the body stowable in a substantially horizontal position.

2. The portable high-definition television and theater entertainment and audio visual system according to claim 1, wherein the movable panel is arranged with a projection screen side and an opposite second side, the opposite second side being exposed when the panel is stowed about the body, and wherein the movable panel cooperates with the generally horizontal top seat to deploy in an approximately vertical position to receive a projected visual image from the at least one audio visual component.

3. The portable high-definition television and theater entertainment and audio visual system according to claim 2, wherein the movable panel is removable from the pod and adapted to be vertically carried to receive an image projected from the at least one audio visual component.

4. The portable high-definition television and theater entertainment and audio visual system according to claim 1, wherein the component cage is adjustable about its alignment guides relative to the alignment passageways to align an image projected from the at least one audio visual component.

5. The portable high-definition television and theater entertainment and audio visual system according to claim 1, further comprising:
at least one movable structure cooperating with the at least one side wall to define the body and the interior component volume, and configured for movement about a recess slide rail to expose and conceal the interior component volume.

6. The portable high-definition television and theater entertainment and audio visual system according to claim 1, wherein the at least one movable structure has at least one door adapted to move about a recess slide rail carried about the at least one side wall whereby the at least one door is at least partially recessible within the interior component volume.

7. The portable high-definition television and theater entertainment and audio visual system according to claim 1, wherein the removable component cage further comprises at least one connector cable retainer for releasably concealing a plurality of conductors of the at least one audio visual component.

8. The portable high-definition television and theater entertainment and audio visual system according to claim 1, wherein the removable component cage is further formed with a plurality of shelves with laterally spaced apart, superiorly projecting handles and a plurality of inferiorly projecting alignment guide feet arranged to releasably engage the alignment passageways to enable adjustability of the component cage relative to the pod.

9. The portable high-definition television and theater entertainment and audio visual system according to claim 1, the pod further comprising:
a plurality of movable doors adapted to cooperate with the at least one side wall to define the interior component volume; and
wherein at least one of the plurality of movable doors is configured for movement about recess slide rails to close and conceal the interior component volume, and to open and be repositioned and recessed in the body, and wherein another of the plurality of movable doors is included about a rear side of the pod to be movable about another recess slide rail to expose a backplane of the at least one audio visual component.

10. A portable high-definition television and theater entertainment and audio visual system, comprising:
a pod formed with at least one side wall cooperating with a generally horizontal top to define a body having an interior component volume and with spaced apart alignment passageways defined about the body;
a removable component cage received within the body and formed with alignment guides arranged to engage the alignment passageways, and being further configured to carry at least one audio visual component; and
a movable and reversible panel vertically positioned to receive a projected image and having a reversible projection screen side and an opposite second side wherein the panel is selected from the group that includes:
(a) a table-top panel adapted to be received about the body as a horizontally stowable conventional table-top, and being adapted with a projection screen side;
(b) an additional movable and reversible panel configured to have a dimensional ratio of about sixteen length units in width by about nine length units in height, and having a projection screen side positionable to receive a projected visual image and an opposite second side adapted to decoratively conceal the projection screen when reversed; and
(c) a floor stand mounted height adjustable panel adapted with a projection screen side and reversibly positionable to receive projected visual image, and adapted with an opposite second side configured to decoratively conceal the projection screen when reversed.

11. A portable high-definition television and theater entertainment and audio visual system, comprising:
a pod formed with at least one side wall cooperating with a generally horizontal top to define a body having an interior component volume and with spaced apart alignment passageways defined about the body;
at least one movable door adapted to move about a recess slide rail between a closed position and an open position wherein the at least one door is recessed at least partially within the interior component volume;
a removable component cage received within the body and formed with alignment guides arranged to engage the alignment passageways, and further configured to carry at least one audio visual source component;
a movable panel positioned remotely from the pod about at least one wall bracket and having a projection screen side, the movable panel being reversible about the at least one wall mount to display an opposite second side.

12. The portable high-definition television and theater entertainment and audio visual system according to claim 11, wherein the movable panel cooperates with the generally horizontal top to be stowed in a substantially horizontal position thereupon to conceal the projection screen side and to expose the opposite second side.

13. The portable high-definition television and theater entertainment and audio visual system according to claim 12, wherein the movable panel is removable from the pod and deployable to an easel adapted to establish a generally vertical position remote from the pod.

14. The portable high-definition television and theater entertainment and audio visual system according to claim 11, wherein the component cage adjusts about its alignment guides to an orientation enabling projection of an image to a floor stand mounted projection screen panel remote from the pod.

15. The portable high-definition television and theater entertainment and audio visual system according to claim 11, further comprising the movable panel being selected from a group that includes:
(a) a table-top panel adapted to be received about the body as a horizontally stowable conventional table-top, and being adapted with a projection screen side;
(b) an additional movable and reversible panel configured to have a dimensional ratio of about sixteen length units in width by about nine length units in height, and having a projection screen side positionable to receive a projected visual image and an opposite second side adapted to decoratively conceal the projection screen when reversed; and
(c) a floor stand mounted height adjustable panel adapted with a projection screen side and reversibly positionable to receive projected visual image, and adapted with an opposite second side configured to decoratively conceal the projection screen when reversed.

16. The portable high-definition television and theater entertainment and audio visual system according to claim 11, wherein the removable component cage further comprises at least one connector cable retainer for releasably concealing a plurality of conductors of the at least one audio visual component.

17. The portable high-definition television and theater entertainment and audio visual system according to claim 11, the pod further comprising:
at least one side bottom wall bounding the interior component volume and formed with the spaced apart alignment passageways; and
wherein the removable component cage is further formed with a plurality of shelves joined with laterally spaced apart and superiorly projecting handles and a plurality of inferiorly projecting alignment guide feet arranged to releasably engage the alignment passageways to enable adjustability of the component cage relative to the pod.

18. The portable high-definition television and theater entertainment and audio visual system according to claim 11, the pod further comprising:
a plurality of the at least one movable door adapted to cooperate with the at least one side wall to define the interior component volume; and
wherein the plurality of movable doors are configured for movement to a closed position concealing the interior component volume and an open position exposing the interior component volume and wherein at least one of the plurality of doors is at least partially recessed in the body.

19. A method of projecting a high-definition audio visual display, comprising the steps of:
providing a pod formed with at least one side wall and at least one recessible door, the side wall engaging a generally horizontal top to define a body with an interior component volume, the top coactive with a movable panel having opposite projection screen and second sides and being movable to a substantially vertical orientation;
providing a removable component cage received within the body and formed with a plurality of shelves, the plurality of shelves configured to carry at least one audio visual component;
positioning the component cage to align an image projected from the at least one audio visual component;
deploying the movable panel to a substantially vertical position; and
projecting an image on the projection screen side.

20. The method of projecting a high-definition audio visual display according to claim 19 wherein the step of positioning the component cage further includes the step of removing and positioning the component cage remote from the pod to align the projected image.

21. A method of projecting a high-definition audio visual display, comprising the steps of:
providing a pod formed with at least one side wall and at least one recessible access door, the side wall engaging a generally horizontal top to define a body with an interior component volume and having spaced apart alignment passageways therein;
providing a removable component cage removably received in the body and formed with a plurality of shelves and bottom mounted alignment guides arranged to coact with the alignment passageways, the plurality of shelves configured to carry at least one audio visual component;
providing at least one reversible movable panel that incorporates a projection screen side and a second opposite side;
positioning the component cage to align an image projected from the at least one audio visual projector, and positioning the at least one reversible movable panel to receive the projected image; and
projecting an image on the projection screen side.

22. The method of projecting a high-definition audio visual display according to claim 21 wherein the step of positioning the component cage further includes the step of removing and positioning the component cage remote from the pod to align the projected image.

23. A deployable component cage, comprising:
a removable component cage received within the interior component volume and formed with alignment guides adapted to coact with the alignment passageways;
at least one shelf adapted with at least one cable retainer and adapted to receive and retain the at least one audio visual component;
a plurality of retainer posts repositionably fixed to the at least one shelf and adapted to retain the at least one audio visual component; and
at least one handle fixed to the removable component cage.

24. A reversible frame comprising:
an edge frame formed to have a panel seat adapted to receive a replaceable panel support core, and having a plurality of bracket seats that sandwich the panel seat, the edge frame further adapted with interior support tabs defining a corner joint keyway configured to receive an angle joiner; and
a releasable edge rail defining at least one side of the edge frame and which is removable to enable removable and replacement of the panel support core.

25. A floor standing frame comprising:
a floor support with opposite ends each received with upstanding risers, each riser defined with an adjustable height pivot slot having a pivot keyway extending to a plurality of lock slots;
a reversible edge frame adapted with one side formed as a releasable rail edge; and
a plurality of pivot bearings positioned between and coacting with the edge frame and pivot slots, each pivot bearing adapted with pivot lock seats sized for repositionable receipt in the lock slots.

26. A portable high-definition television and theater entertainment and audio visual system, comprising:
a pod formed with at least one side wall cooperating with a generally horizontal top seat to define a body having an interior component volume adapted to carry at least one audio visual component;
a movable panel stowable about the body in a substantially horizontal position; and
wherein the movable panel includes a projection screen side and an opposite second side, the opposite second side being exposed when the panel is stowed about the body, and the movable panel is removable from the pod to be vertically carried and receive an image projected from the at least one audio visual component.
